(19) United States
(12) Patent Application Publication
(10) Pub. No.: US 2004/0163603 A1
(43) Pub. Date: Aug. 26, 2004

(54) Multipurpose disposable pet mattress pad cover

(76) Inventor: Gloria Newton, Seattle, WA (US)

Correspondence Address: Charles J. Rupnick, PO Box 46752, Seattle, WA, 98146, US

(21) Appl. No.: 10/372,564

(22) Filed: Feb. 21, 2003

(51) Int. Cl. A01K 29/00

(52) U.S. Cl. 119/28.5

(57) ABSTRACT

A multipurpose disposable contour sheet for protecting a pet bed mattress or grooming table from shed pet hair, water, soil and tear damage, the disposable contour sheet being formed of a single flat unfolded and unbroken substantially rectangular sheet of garment interfacing fabric resistant to soiling, snagging, running and tearing and tends to capture for “net” shed pet hair; and a strip of elastic tape attached along substantially the entirety of a peripheral edge of the fabric sheet, and thereby forming the fabric sheet into contour sheet sized to cover an upper and side surfaces of a pet bed mattress or grooming table and having an elasticized opening therein sized to admit the pet bed mattress or grooming table.

### FIELD OF THE INVENTION

The present invention relates to mattress cover devices and methods, and in particular to multipurpose disposable covers for pet mattress pads and pet grooming tables.

### BACKGROUND OF THE INVENTION

Many pet owners provide pet bed pillows or mattress pads for their pets to lie and sleep upon. These pet mattress pads may become soiled, snagged, run or torn by the pet. They may also become damp or soiled by moisture secreted by the pet. The mattress pad may also become littered with hair shed by the pet or brushed out by the owner. Pet grooming tables are prone to the same damage and are more likely to become littered with hair as an owner or trainer grooms the pet, as for showing.

FIG. 1 illustrates a conventional pet bed pillow or mattress pad 1 usually formed of foam rubber in a fabric envelope or “pillow case,” but may be filled with fiber batting or another suitable mattress material. The pet bed mattress pad 1 is usually rectangular (shown), round or oblong in shape. Typically, the pet bed mattress pad 1 ranges in surface width W and length L from 15″ by 19″ to 32″ by 40″ with intermediately sized pads sized 19″ by 25″ and 25″ by 32″. Round and oblong shaped mattresses are similarly sized. Thickness T of the pet bed mattress pad 1 is usually about 5″ thick regardless of the bed size.

Covers for pet pillows or mattress pads are well known. Fitted mattress covers are also well known, as are disposable pad or mattress covers.

U.S. Pat. No. 2,963,715 entitled CONTOUR SHEET FOR MATTRESSES, for example, describes a contour sheet for mattresses. The contour sheet has a flat rectangular sheet of the approximate dimensions of the mattress surface, with the sheet being formed of an upper face of woven fibers and an under face of an adherent film of a liquid repellent synthetic plastic material. One edge of a long narrow substantially rectangular strip of fabric is stitched to the edges of the sheet with an elastic tape stitched to the other edge of the strip while the tape is in the stretched condition, the tape being stitched in a folded position over the other edge of the strip.

U.S. Pat. No. 4,744,118 entitled DISPOSABLE FITTED CRIB OR BED SHEET, describes a fitted sheet for covering a standard crib or bed mattress. The fitted sheet is developed from a single rectangular blank of non-woven fabric material, the sides of which are folded in along parallel longitudinal fold lines to form a folded-in sheet having a width that corresponds to the mattress for which it is intended, and a length that exceeds the mattress to an extent necessary to define the ends of the fitted sheet. Each corner of the folded-in sheet is seamed along a diagonal line to form a triangular flap which, when the sides of the folded-in sheet are folded over the sides of the mattress, defines a right angle corner that fits against the corresponding corner of the mattress. Each end of the fitted sheet is rendered stretchable by an elastic strip, whereby the fitted sheet conforms snugly to the mattress.

U.S. Pat. No. 5,630,376 entitled ABSORBENT COMPOSITE PANEL FOR PET ANIMAL, describes an absorbent composite panel formed of a liquid-absorbent panel and a liquid-impermeable back sheet. The top surface of the absorbent panel is partially covered along its peripheral edges with liquid-impermeable overflow barrier strips which are then bonded integrally to the back sheet along their outer side edges, with the inner side edge of the overflow barrier strips being spaced from the top surface of the absorbent panel by a desired distance.

U.S. Pat. No. 5,727,266 entitled DISPOSABLE PILLOW OR CUSHION COVER, describes a disposable pillow or cushion cover that is formed by an envelope of air and moisture impermeable material. The envelope encases the pillow or cushion and provides an impermeable resting surface upon which a user may rest the head or other body part on a clean, comfortable, fresh, hygienic, fragrant resting surface without having to change pillows, cushion covers or envelopes. The envelope contains a vent to permit ingress and egress of air from the pillow or cushion. The envelope also includes a sealable opening to permit insertion and removal of the pillow or cushion. A facing layer of air permeable material extends over the resting surface and is secured to the envelope at spaced apart locations to allow air flow and a degree of relative movement between the facing layer and envelope.

U.S. Pat. No. 4,649,861 entitled PET MAT, describes a pet mat for domestic animals. The mat is formed from a top layer, a bottom layer, and an intermediate layer. The top layer is insect pervious to allow insects such as fleas and ticks to travel into the intermediate layer. A wet or slow drying adhesive is located either on the bottom surface of the top layer, on the top surface of the bottom layer, or in the intermediate layer. The adhesive may be mixed with pheromones or bait to attract the insects or fleas. Insects or fleas are intended to touch the adhesive and be unable to release themselves from it.

Through use, the fabric envelope covering the pet bed mattress 1 eventually becomes soiled or damaged, and the pet owner must either clean and repair or replace it. This is a serious limitation suffered by each of these and other known fitted sheets, pet pillows or mattress pads. Pet grooming tables are also known to suffer the limitation of becoming soiled and littered with hair shed or brushed from the pet.

### SUMMARY OF THE INVENTION

The present invention provides a multipurpose disposable contour sheet that overcomes many of the limitations of the known fabric sheets, pet pillows or mattress pads of the prior art for protecting a pet bed mattress from water, soil and tear damage. Accordingly, the disposable contour sheet of the invention is formed of a single flat unbroken and unfolded rectangular sheet of conventional interfacing fabric that is resistant to soiling, snagging, running and tearing in combination with a strip of elastic tape attached along substantially the entirety of a peripheral edge of the fabric sheet, and thereby forms the fabric sheet into contour sheet sized to cover at least an upper and side surfaces of a pet bed mattress and having an elasticized opening therein sized to admit the pet bed mattress.

The multipurpose contour sheet of the invention thus provides protection for a pet bed mattress from water, soil and tear damage in a form unknown in the prior art, where the sheet is formed in a novel unbroken substantially rectangular flat pattern with an elastic band sewn in its stretched condition along substantially the entirety of the peripheral edge of the rectangular sheet.

The combination of the unbroken and unfolded substantially rectangular flat-patterned sheet with the peripheral elastic band permits the contour sheet to be manufactured without any cutting, folding or sewing steps of the prior art being applied to the rectangular sheet. The novel combination of the unbroken and unfolded substantially rectangular sheet with the peripheral elastic band thus results in manufacture of the contour sheet with far fewer steps than prior art contour sheets, and far fewer parts relative to many prior art contour sheets.

Novel use of garment interfacing fabric provides many of the advantages of prior art contour sheets, while eliminating the need for the multiple layers of different materials used in prior art contour sheets. The novel use of the interfacing fabric additionally provides a contour sheet that resists or completely eliminates snags, runs and tears above an beyond any contour sheet taught in the prior art, while protecting a pet bed mattress from water, soil and tear damage. A frictional or “netting” characteristic of the interfacing fabric catches hair that is shed by the pet brushed loose during grooming. Furthermore, the hypoallergenic nature of the interfacing fabric protects the pet from reactions that might otherwise be harmful to health and well-being.

According to one aspect of the invention, novel selection of the sheet of garment interfacing fabric and elastic tape render the contour sheet of the invention disposable.

According to another aspect of the invention, the interfacing fabric further is formed of one or more of polyester, rayon and nylon fibers, the fibers being non-woven and distributed at random and being held together by chemical binders and heat.

According to another aspect of the invention, the contour sheet is formed of a garment interfacing fabric that, while disposable, may also be washed and dried by conventional means.

According to another aspect of the invention, the fabric sheet is sized to cover the upper and side surfaces of a pet bed mattress having a thickness of approximately 5 inches. The fabric sheet is sized to fit any selected one of several different conventionally sized pet bed mattresses. The selection includes, for example, pet bed mattresses that are approximately 15 inches wide by 19 inches long, 19 inches wide and 25 inches long, 25 inches wide and 32 inches long, and 32 inches wide and 40 inches long.

According to yet another aspect of the invention, the fabric sheet is further sized to cover a portion of a bottom surface of the pet bed mattress adjacent to the side surfaces.

According to yet another aspect of the invention, the fabric sheet is further sized to cover a pet grooming.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a conventional pet bed pillow or mattress pad;

FIG. 2 illustrates manufacturing of the disposable contour sheet of the invention;

FIG. 3 is a top-down perspective view of the apparatus of the invention embodied as a disposable contour sheet emplaced over the mattress pad of FIG. 1; and

FIG. 4 is a bottom-up perspective view of the apparatus of the invention embodied as a disposable contour sheet emplaced over the mattress pad of FIG. 1.

### DETAILED DESCRIPTION OF PREFERRED EMBODIMENT

In the Figures, like numerals indicate like elements.

The present invention is multipurpose disposable contour sheet and method for protecting a pet bed mattress from water, soil and tear damage. The disposable contour sheet is formed of a single flat and unbroken sheet of heavy hypoallergenic garment interfacing fabric sized to cover completely an upper surface and sides of a mattress and to further extend to partly cover a bottom surface thereof, and having a strip of elastic tape stitched at or near to a peripheral edge of the sheet of interfacing fabric while the elastic tape is in a stretched condition, the strip of elastic tape thereby forming an opening into an otherwise closed bubble shape formed by the sheet of interfacing fabric when the elastic tape is relaxed in an unstretched condition. Furthermore, the multipurpose disposable contour sheet of the invention is sized to completely cover an upper surface of a conventional pet grooming table.

FIG. 2 illustrates manufacturing of the multipurpose disposable contour sheet 10 of the invention embodied as a sheet 12 of garment interfacing fabric laid in a flat pattern. As illustrated, the disposable contour sheet 10 of the invention is formed of a single flat, unbroken and unfolded sheet of heavy interfacing fabric that is soil, snag, run and tear resistant, while being pliant and semi-absorbent of water and adhering loose hair to itself. Known prior art use of interfacing fabric is limitedo the garment, upholstery and craft industries. Interfacing is a supportive fabric that is placed between the facing and garment fabric. Interfacing is commercially available as woven, non-woven or knit fabrics that can be applied by fusing (fusible) or sewing (sew-in). Non-woven interfacings are usually made of polyester, rayon, nylon or a blend of these fibers. The fibers are distributed at random and held together by chemical binders and heat. Because they do not have a yarn direction or grain, non-woven interfacings do not ravel and can be cut in any direction.

The weight and amount of stretch of non-woven interfacing fabrics vary significantly. Some non-woven interfacing fabrics are relatively stable; others have varying amounts of stretch or give. Non-woven stabilized interfacings do not give or stretch appreciably in any direction. Interfacing weights vary from sheer to quite heavy. The heavy non-woven stabilized interfacings are primarily used for purses, draperies and craft projects, and may be desirable in the garment industry primarily for applications such as buttonholes and waistbands.

Such interfacing fabrics are commercially available, for example, from both Phoenix Fabric Outlet of Phoenix, Ariz. and Real Supply Company of Duvall, Wash.

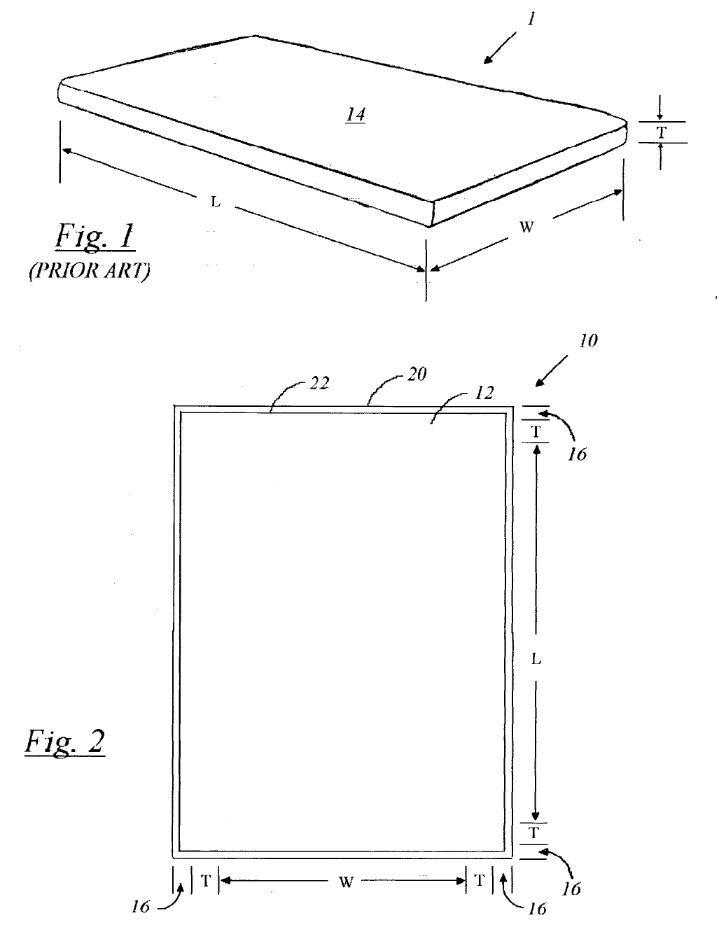

According to one embodiment of the invention, the disposable contour sheet 10 is formed of a single flat, unfolded and unbroken substantially rectangular sheet 12 of such heavy non-woven stabilized interfacing material. The sheet 12 is sized to completely cover the width W and length L of an upper surface 14 of a conventional rectangular pet bed mattress pad 1 of the type illustrated in FIG. 1. The size of sheet 12 includes the pad thickness T on all four sides of the rectangular shape, and additionally includes an extension 16 of about three inches all around its peripheral edge to partially extend over a bottom surface 18 of the mattress pad 1, as shown in FIG. 4. The sheet 12 is thus sized in flat pattern to have a width equal to the sum of the width W of the mattress pad 1, two times the pad thickness T, and two times the width of the extension 16. In length of flat pattern of the sheet 12 is sized to be the sum of the length L, two times the pad thickness T, and two times the width of the extension 16. These three sizes are also appropriate for completely covering at least the useful top surface of most conventional rigid and collapsible pet grooming tables.

A strip or tape 20 of a stretchable material is attached about a peripheral edge 22 of the sheet 12. For example, the tape of stretchable material is 1/16″ or ⅛″ fine elastic of a type commercially available from, for example, Fulflux, Incorporated of Middletown, R.I. While in a stretched condition, the elastic tape 20 is sewn or otherwise attached at or near the peripheral edge of the sheet 12. Alternatively, the elastic tape 20 is captured within a tubular hem sewn about the peripheral edge of the sheet 12.

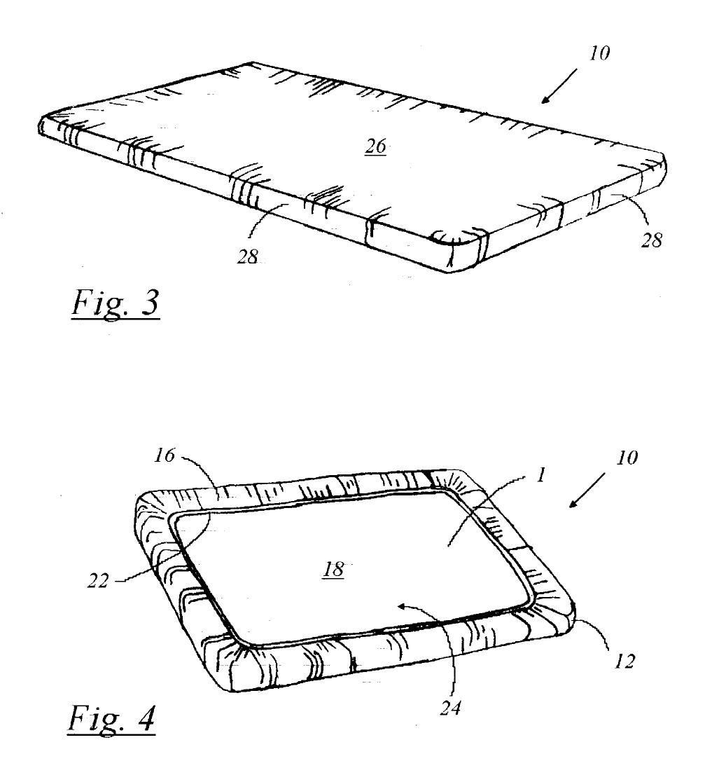

FIGS. 3 and 4 illustrate the apparatus and method of the invention for protecting a pet bed mattress from water, soil and tear damage embodied as the disposable contour sheet 10. The disposable contour sheet 10 is illustrated, by example and without limitation, emplaced on a conventional rectangular pet bed pillow or mattress pad 1. The disposable contour sheet 10 is also practiced in combination with either round or oblong pet bed mattress pads without change in either the flat pattern of the sheet 12 of interfacing fabric or its relaxed bubble shape.

In a relaxed and unstretched condition the elastic tape 20 operates to gather all of the peripheral edges of the flat sheet 12 to form the bubble-shaped or “bouffant” disposable contour sheet 10. An opening 24 in the bubble-shaped disposable contour sheet 10 is formed by the strip of elastic tape 20 attached about its circumferential edge 22. The size of the opening 24 is sufficient to admit the mattress pad 1.

In practice, the multipurpose disposable contour sheet 10 is fit over the mattress pad 1, such that a central portion 26 of the sheet 12 covers the upper surface 14 of the mattress pad 1, peripheral portions 28 cover the pad thickness, and the extensions 16 are gathered by tension produced by the elastic tape 20 to cover a peripheral portion of the bottom surface 18. Tension in the elastic tape 20 fixes the disposable contour sheet 10 in place and helps to smooth the central portion 26 of the sheet 12 over the upper surface 14 of the mattress pad 1.

The multipurpose disposable contour sheet 10 of the invention formed by the sheet 12 of interfacing fabric thus provides in a single layer of material a hypoallergenic barrier that is proof against soiling and against snagging, running and tearing by the pet's claws, but yet absorbs small amounts of moisture that may being secreted by the pet. The structure of the fibers forming the non-woven stabilized interfacings exhibit a frictional characteristic that tends to capture or “net” hair shed by the pet.

The elasticized opening 24 permits the contour sheet 10 of the invention to be changed quickly. Because of its simple design and inexpensive manufacture, the contour sheet 10 of the invention can be cost effectively disposed without resort to bothersome cleaning. The conventional interfacing fabric used in making the contour sheet 10 of the invention may however be cleaned by conventional water or dry cleaning methods, and according to one embodiment of the invention, the contour sheet 10 can be machined washed and tumble dried. Therefore, although disposable, the contour sheet 10 can be cleaned and reused, if desired.

As described, the bubble-shaped disposable contour sheet 10 is sized and shaped to accept either round or oblong-shaped mattress pads of the same general width, length and thickness and.

The multipurpose disposable contour sheet 10 of the invention is also useful for covering a portable rigid or collapsible pet grooming table of a type well known in the art or other furniture for pet grooming. See, for example, U.S. Pat. No. D369,443, entitled PET FURNITURE FOR SLEEPING, GROOMING OR BATHING, issued to Givens on Apr. 30, 1996, and U.S. Pat. No. D290,767, entitled COMBINED CAT HOUSE AND PLATFORM, issued to Duffek on Jul. 7, 1987, both incorporated herein by reference. Collapsible and rigid pet grooming tables are known to come in various sizes, including sizes generally in the ranges of the pet mattress pads discussed herein. The multipurpose disposable contour sheet 10 of the invention is thus appropriately sized to cover these grooming tables. The hair catching or “netting” characteristic of conventional non-woven stabilized interfacing thus serves to capture hair shed by the pet or loosed during grooming, and is then disposed by the user. The multipurpose disposable contour sheet 10 of the invention thereby serves to maintain the cleanliness of the grooming table.

While the preferred embodiment of the invention has been illustrated and described, it will be appreciated that various changes can be made therein without departing from the spirit and scope of the invention.

What is claimed is:

1. A multipurpose disposable contour sheet for a pet bed mattress, the disposable contour sheet comprising:
an unbroken and unfolded sheet of interfacing fabric sized to cover completely an upper surface and sides of a mattress and to partly cover a bottom surface thereof; and
a strip of stretchable material attached to a peripheral edge of the sheet of interfacing fabric while the stretchable material is in a stretched condition.

2. The contour sheet of claim 1 wherein the sheet of interfacing fabric further comprises only a single sheet of fabric.

3. The contour sheet of claim 2 wherein the sheet of interfacing fabric further comprises a heavy non-woven stabilized interfacing fabric formed of one or more of polyester, rayon and nylon fibers.

4. The contour sheet of claim 1 wherein the strip of stretchable material is sewn to the peripheral edge of the sheet of interfacing fabric.

5. The contour sheet of claim 1 wherein the sheet of interfacing fabric further comprises a substantially rectangular flat pattern prior to attachment of the strip of stretchable material.

6. The contour sheet of claim 5 wherein the substantially rectangular flat pattern further comprises a flat pattern sized to include rectangular width and length dimensions of the upper surface of the mattress, the thickness of the mattress on each of the four sides of the rectangular width and length dimensions, and an extension all around the peripheral edge of the flat pattern.

7. A multipurpose contour sheet for protecting a pet bed mattress or grooming table from water, soil and tear damage, the disposable contour sheet comprising:
a single flat unfolded and unbroken substantially rectangular sheet of fabric that is resistant to soiling, snagging, running and tearing; and
a strip of elastic tape attached along substantially the entirety of a peripheral edge of the fabric sheet, and thereby forming the fabric sheet into contour sheet sized to cover an upper and side surfaces of a pet bed mattress and having an elasticized opening therein sized to admit the pet bed mattress.

8. The contour sheet of claim 7 wherein the fabric sheet and elastic tape are selected to render the contour sheet disposable.

9. The contour sheet of claim 7 wherein the fabric sheet further comprises conventional garment interfacing fabric.

10. The contour sheet of claim 9 wherein the interfacing fabric further comprises a hypoallergenic interfacing fabric formed of one or more of non-woven and randomly distributed polyester, rayon and nylon fibers.

11. The contour sheet of claim 7 wherein the sheet of fabric further comprises fabric that tends to adhere hair to itself.

12. The contour sheet of claim 7 wherein the fabric sheet further comprises a fabric being washable by conventional means.

13. The contour sheet of claim 7 wherein the fabric sheet is sized to cover the upper and side surfaces of a pet bed mattress having a thickness of approximately 5 inches and a combination of approximate width and length dimensions that are selected from the list of combinations of approximate width and length dimensions of: 15 inches width and 19 inches length, 19 inches width and 25 inches length, 25 inches width and 32 inches length, and 32 inches width and 40 inches length.

14. The contour sheet of claim 13 wherein the fabric sheet further comprises sufficient material at the peripheral edge to extend over a portion of a bottom surface of the pet bed mattress adjacent to the side surfaces.

15. A contour sheet for protecting a pet bed mattress or grooming table from water, soil and tear damage, the disposable contour sheet comprising:
an unbroken bubble shape formed by a sheet of hypoallergenic garment interfacing fabric having an unbroken and unfolded substantially rectangular flat pattern, the bubble shape being sized to fit over an upper and side surfaces of a selected pet bed mattress or grooming table and having an opening therein sized to admit the selected pet bed mattress or grooming table; and
a strip of elastic tape attached to the circumferential edge of the opening and being sized to stretch sufficiently to admit the selected pet bed mattress or grooming table through the opening in the bubble shape and to generate a tension in the fabric at least over a portion of the upper surface of the selected pet bed mattress or grooming table.

16. The contour sheet of claim 15 wherein the unbroken bubble shape formed by the sheet of interfacing fabric further comprises sufficient fabric to extend over a portion of a bottom surface of the selected pet bed mattress or grooming table adjacent to the side surfaces.

17. The contour sheet of claim 15 wherein the bubble shape is further sized to fit over an upper and side surfaces of a pet bed mattress or grooming table selected from a group of differently sized pet bed mattresses each having a thickness of about 5 inches.

18. The contour sheet of claim 17 wherein one of the group of differently sized pet bed mattresses is sized having an approximate width of 15 inches and an approximate length of 19 inches, a second one of the group of pet bed mattresses is sized having an approximate width of 19 inches and an approximate length of 25 inches, a third one of the group of pet bed mattresses is sized having an approximate width of 25 inches and an approximate length of 32 inches, and a fourth one of the group of pet bed mattresses is sized having an approximate width of 32 inches and an approximate length of 40 inches.

19. The contour sheet of claim 15 wherein the sheet of interfacing fabric further comprises a sheet of heavy, non-woven stabilized interfacing fabric.

20. The contour sheet of claim 19 wherein the sheet of interfacing fabric further comprises an interfacing fabric formed of one or more of polyester, rayon and nylon fibers.
